(19) United States
(12) Patent Application Publication
(10) Pub. No.: US 2026/0070416 A1
(43) Pub. Date: Mar. 12, 2026

(54) SELECTIVELY POSITIONABLE VEHICLE CONTROL INTERFACE AND METHOD

(71) Applicant: International Truck Intellectual Property Company, LLC, Lisle, IL (US)

(72) Inventor: Eric Michael Dluzen, Aurora, IL (US)

(73) Assignee: International Truck Intellectual Property Company, LLC, Lisle, IL (US)

(21) Appl. No.: 18/828,532

(22) Filed: Sep. 9, 2024

(51) Int. Cl. B60K 35/53; B60K 35/22

(52) U.S. Cl. CPC B60K 35/53; B60K 35/22; B60K 2360/131

(57) ABSTRACT

A vehicle control interface for use with a vehicle is provided for affecting operation of vehicle features using movable controls. The vehicle control interface for use with a vehicle may include an selectively positionable interface component, communication module, housing, and mounting interface. A method for affecting operation of vehicle features using movable controls using the selectively positionable vehicle control interface for use with a vehicle is also provided.

### FIELD OF THE INVENTION

The present disclosure relates to a selectively positionable control interface for use with a vehicle. More particularly, the disclosure relates to affecting operation of vehicle features using movable controls.

### BACKGROUND

In a variety of vehicles, many control interfaces for frequently used vehicle features are located out of the driver's reach or view. For example, the buttons or switches for adjusting the air conditioning, cabin lights, or radio may be on the dashboard, center console, or door panels. To access these control interfaces, the driver may often have to stretch their arm, lean forward, or look away from the road, which can compromise their driving safety and comfort. Moreover, these control interfaces are fixed in positions and cannot be customized according to the driver's preferences or needs.

Therefore, a need exists to solve the deficiencies present in the prior art. What is needed is a control interface to affect operation of vehicle features to be within arm's length when driving a vehicle. What is needed is a control interface for vehicle features to be repositionable throughout the interior of a vehicle. What is needed is a wirelessly preconfigured movable control interface to improve safety, convenience, and operability of controlling vehicle functions.

### SUMMARY

An aspect of the disclosure advantageously provides a control interface to affect operation of vehicle features to be within arm's length when driving a vehicle. An aspect of the disclosure advantageously provides a control interface for vehicle features to be repositionable throughout the interior of a vehicle. An aspect of the disclosure advantageously provides a wirelessly preconfigured movable control interface to improve safety, convenience, and operability of controlling vehicle functions.

Accordingly, the disclosure may feature a vehicle control interface for use within a vehicle. The control interface may comprise a selectively positionable interface component which may receive a control input to affect an operational state of a vehicle feature. The selectively positionable interface component may comprise a communication module which may be preconfigured to communicate with a vehicle communication radio of the vehicle. The vehicle communication radio may be electrically connected to the vehicle feature which may be controlled by the control input. A housing may substantially enclose the communication module and may partially enclose the selectively positionable interface component. The housing may comprise a mounting interface to removably attach the housing to a vehicle mounting location of the vehicle.

In another aspect, the mounting interface may exchangeably receive mounting hardware.

In another aspect, the mounting hardware may comprise a suctioning mechanism.

In another aspect, the selectively positionable interface component may comprise a display comprising a screen that may present variable inputs to a user via a graphic user interface.

In another aspect, the display may further comprise a digitizer to receive variable inputs corresponding with the graphic user interface.

In another aspect, the control input may affect operation of an entertainment system of the vehicle.

In another aspect, the control input may affect operation of an interior light of the vehicle.

In another aspect, the control input may affect operation of a climate control system of the vehicle.

In another aspect, the selectively positionable interface component may include a dial.

In another aspect, the selectively positionable interface component may include a rocker switch.

In another aspect, the mounting interface may comprise a magnet which may correspond to a complementary magnetic surface provided by the vehicle.

In another aspect, the complementary magnetic surface may be preinstalled to the vehicle.

According to an embodiment of this disclosure, a method is provided for using a vehicle control interface to control a vehicle feature. The method may include (a) locating a selectively positionable interface component adjacent to a vehicle mounting location of the vehicle. The selectively positionable interface component may comprise a communication module being preconfigured to communicate with a vehicle communication radio of the vehicle. The vehicle communication radio may be electrically connected to the vehicle feature being controlled by the control input. The method may include removably mounting a housing to the vehicle mounting location, wherein the housing may substantially enclose the communication module and at least partially encloses the selectively positionable interface component. The housing may comprise a mounting interface to removably attach the housing to the vehicle mounting location. The method may additionally include (b) establishing a communication between the vehicle communication radio and the communication module. The method may additionally include (c) receiving a control input which may be communicated to the vehicle communication radio. The method may additionally include (d) translating the control input to an electrical signal to be received by a vehicle feature.

In another aspect, the method may include a selectively positionable interface component that may comprise a display which may comprise a digitizer and a screen that presents variable inputs to a user via a graphic user interface. The method may additionally include (e) receiving the control input via a digitizer to receive the variable inputs corresponding with the graphic user interface.

In another aspect, the method may include the mounting interface that may comprise a magnet corresponding to a complementary magnetic surface provided by the vehicle. The method may additionally include removably mounting the magnet of the mounting interface to the complementary magnetic surface.

Terms and expressions used throughout this disclosure are to be interpreted broadly. Terms are intended to be understood respective to the definitions provided by this specification. Technical dictionaries and common meanings understood within the applicable art are intended to supplement these definitions. In instances where no suitable definition can be determined from the specification or technical dictionaries, such terms should be understood according to their plain and common meaning. However, any definitions provided by the specification will govern above all other sources.

Various objects, features, aspects, and advantages described by this disclosure will become more apparent from the following detailed description, along with the accompanying drawings in which like numerals represent like components.

### BRIEF DESCRIPTION OF THE DRAWINGS

FIG. 1 is a perspective view of multiple selectively positionable control interfaces in use in a vehicle, according to an embodiment of this disclosure.

FIG. 2 is a perspective view of a selectively positionable vehicle control interface for use within a vehicle, according to an embodiment of this disclosure.

FIG. 3 is a side elevation view of an alternative embodiment of a selectively positionable vehicle control interface for use within a vehicle, according to an embodiment of this disclosure.

FIG. 4 is a perspective view of an alternative embodiment of a selectively positionable vehicle control interface for use within a vehicle, according to an embodiment of this disclosure.

FIG. 5 is a front elevation view of a selectively positionable vehicle control interface for use within a vehicle, according to an embodiment of this disclosure.

FIG. 6 is a sectional view of the selectively positionable vehicle control interface for use within a vehicle shown in FIG. 5, according to an embodiment of this disclosure.

FIG. 7 is a front elevation view of a selectively positionable vehicle control interface for use within a vehicle, according to an embodiment of this disclosure.

FIG. 8 is a flowchart view of an illustrative method for using a selectively positionable vehicle control interface, according to an embodiment of this disclosure.

### DETAILED DESCRIPTION

The following disclosure is provided to describe various embodiments of a selectively positionable vehicle control interface for use with a vehicle. Skilled artisans will appreciate additional embodiments and uses of the present invention that extend beyond the examples of this disclosure. Terms included by any claim are to be interpreted as defined within this disclosure. Singular forms should be read to contemplate and disclose plural alternatives. Similarly, plural forms should be read to contemplate and disclose singular alternatives. Conjunctions should be read as inclusive except where stated otherwise.

Expressions such as “at least one of A, B, and C” should be read to permit any of A, B, or C singularly or in combination with the remaining elements. Additionally, such groups may include multiple instances of one or more element in that group, which may be included with other elements of the group. All numbers, measurements, and values are given as approximations unless expressly stated otherwise.

For the purpose of clearly describing the components and features discussed throughout this disclosure, some frequently used terms will now be defined, without limitation. The term radio, as it is used throughout this disclosure, is defined as the wireless transmission and reception of electric impulses or signals by means of electromagnetic waves. The term entertainment system, as it is used throughout this disclosure, is defined as a collection of hardware and software in vehicles that provides audio and/or video entertainment. The term vehicle, as it is used throughout this disclosure, is defined as an automative vehicle not operated on rails, including, but not limited to, cars and trucks. The term vehicle feature, as it is used throughout this disclosure, is defined as elements in a vehicle that provide for additional functionality.

Various aspects of the present disclosure will now be described in detail, without limitation. In the following disclosure, a selectively positionable vehicle control interface for use with a vehicle will be discussed. Those of skill in the art will appreciate alternative labeling of the selectively positionable vehicle control interface for use with a vehicle as a repositionable vehicle feature control, selectively moveable control interface for vehicle features, selectively positionable vehicle control interface for use within a truck or other automobile, the invention, or other similar names. Similarly, those of skill in the art will appreciate alternative labeling of the selectively positionable vehicle control interface for use with a vehicle as an operation for controlling vehicle features using a movable interface, method for selectively positioning and controlling vehicle features using a repositionable interface, technique for remotely controlling features, method, operation, the invention, or other similar names. Skilled readers should not view the inclusion of any alternative labels as limiting in any way.

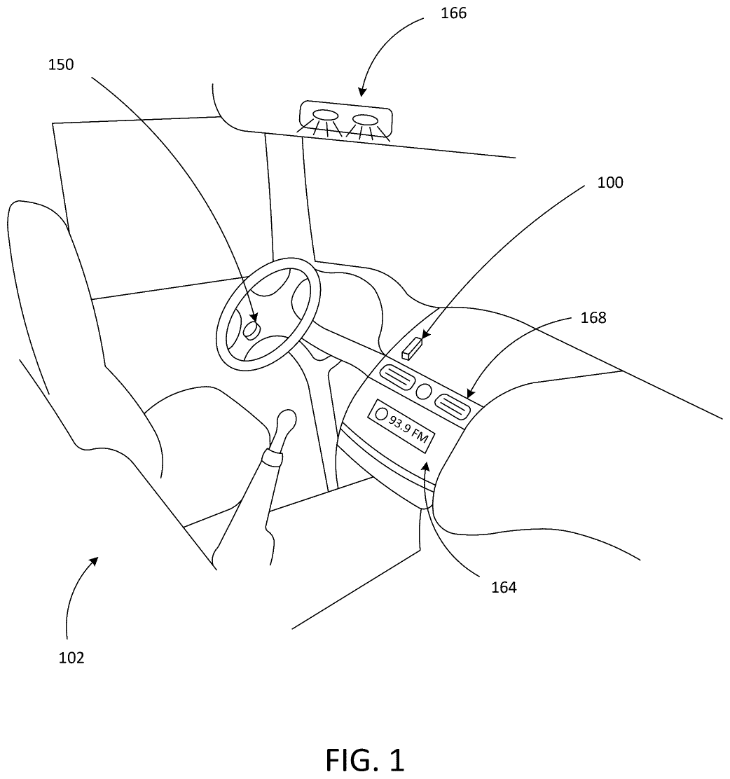

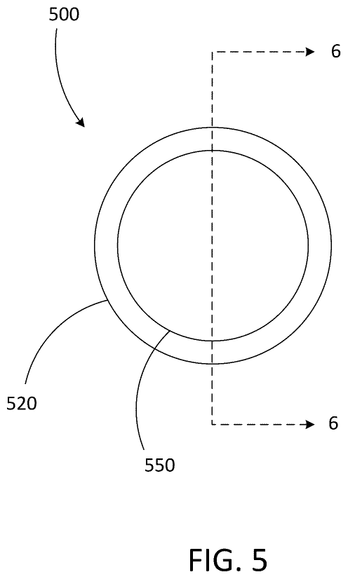

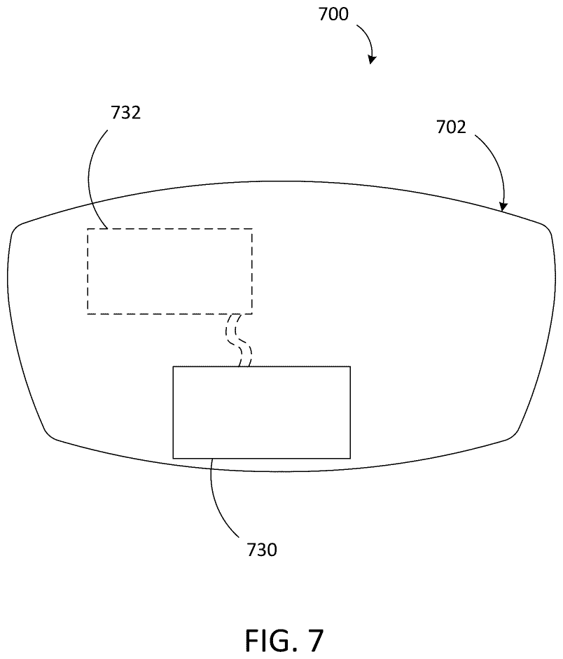

Referring now to FIGS. 1-8, the vehicle control interface for use with a vehicle will now be discussed in more detail. The vehicle control interface 100, 200, 300, 400, 500, 600, 700 for use with a vehicle 102, 602, 702 may include a selectively positionable interface component 210, 410, communication module 612, housing 220, 320, 420, 520, 620, mounting interface 322, and additional components that will be discussed in greater detail below. The vehicle control interface 100, 200, 300, 400, 500, 600, 700 for use with a vehicle 102, 602, 702 may operate one or more of these components interactively with other components for affecting operation of vehicle features 730 using movable controls.

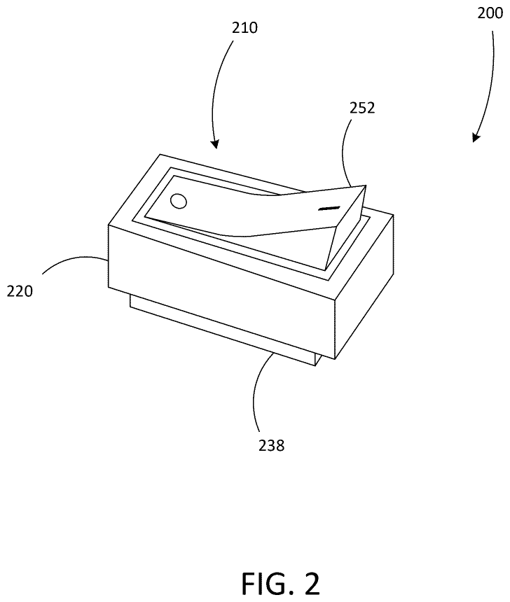

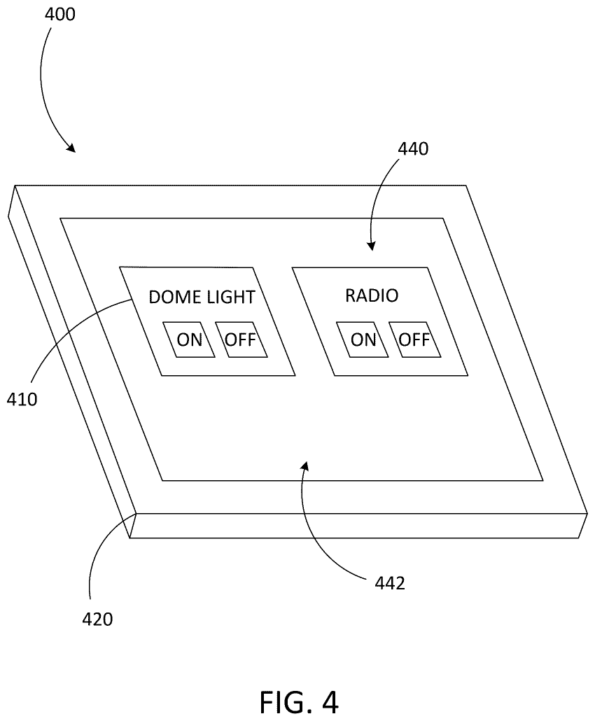

The selectively positionable interface component will now be discussed in greater detail. FIGS. 2 and 4 highlight examples of the selectively positionable interface component 210, 410, which may also be shown in other figures.

In various embodiments, the selectively positionable interface component 210, 410 may comprise the communication module 612, which will be discussed in greater detail below. The housing 220, 320, 420, 520, 620, which will also be discussed in greater detail below, may substantially enclose the communication module 612 and may also at least partially enclose the selectively positionable interface component 210, 410.

Generally, the selectively positionable interface component 210, 410 may receive a control input to affect an operational state of a vehicle feature 730. In many embodiments, the control input may be received via the user performing a physical action onto the selectively positionable interface component 210, 410. Control input entry methods may include, but are not limited to, tapping, clicking, pushing, pressing, indenting, depressing, holding, and squeezing. Those skilled in the art will appreciate other control input entry methods, after having the benefit of this disclosure.

In various embodiments, vehicle features 730 may comprise additional aspects of the vehicle 102, 602, 702 that are often controllable by a user. Vehicle features 730 may include, but are not limited to, a climate control system 168, an interior light 166, an entertainment system 164, adaptive cruise control, a back-up camera, park assist, a navigation system, a sunroof, remote engine ignition, a windshield wiper system, vehicle headlights, a vehicle's front hood, a vehicle's trunk, a seat warmer, a seat cooler, and a rear seat entertainment system. Those skilled in the art will appreciate other vehicle features, after having the benefit of this disclosure.

As previously mentioned, the selectively positionable interface component 210, 410 may manage various aspects of a climate control system 168. These aspects may include, but are not limited to, adjusting the temperature settings of certain parts of the vehicle, adjusting the fan speed, toggling between different air circulation modes, activating or deactivating air conditioning or heating, as well as controlling humidity levels and defrosting windows. However, those skilled in the art will appreciate the various other aspects of the climate control system 168 that may be controlled via a selectively positionable interface component 210, 410 after having the benefit of this disclosure.

As previously mentioned, the selectively positionable interface component 210, 410 may manage various aspects of an interior light 166. These aspects may include, but are not limited to, toggling the dome lights on or off, setting the dome lights to activate automatically when a door is opened, managing ambient light settings, adjusting brightness levels and color hues, activating, or deactivating reading lights, and activating or deactivating footwell lights. However, those skilled in the art will appreciate the various other aspects of the interior light 166 that may be controlled via a selectively positionable interface component 210, 410, after having the benefit of this disclosure.

As previously mentioned, the selectively positionable interface component 210, 410 may manage various aspects of an entertainment system 168. These aspects may include adjusting audio settings such as volume, balance, and fade, switching between different audio sources, accessing preset stations or playlists, accessing navigation or multimedia functions. However, those skilled in the art will appreciate the various other aspects of the entertainment system 168 that may be controlled via a selectively positionable interface component 210, 410 after having the benefit of this disclosure.

In many embodiments, the operational state of a vehicle feature 730 may be affected after the selectively positionable interface component 210, 410 receives a control input. The operational state may comprise of any disposition of the vehicle feature 730 that may be changed. Operational states may include, but are not limited to, powering off, powering on, adjusting a volume state, and adjusting a temperature state. Those skilled in the art will appreciate various other operational states, after having the benefit of this disclosure.

The selectively positionable interface component 210, 410 may comprise different embodiments, which may advantageously provide for an easier interface between the selectively positionable interface component 210, 410 and the vehicle feature 730. The selectively positionable interface component 210, 410 comprise a dial, a rocker switch, a display, a knob, a slider, and/or a handle, without limitation. Those skilled in the art will appreciate the various other selectively positionable interface components that may be used, after having the benefit of this disclosure.

As previously mentioned, the selectively positionable interface component 210, 410 may comprise a dial 150, 350, 550, 650. In various embodiments, the dial 150, 350, 550, 650 may comprise a rotatable knob or wheel. The dial 150, 350, 550, 650 may be mounted on a central spindle or axle that may allow for a smooth rotation while maintaining a secure attachment to the housing 220, 320, 420, 520, 620. In the same or other embodiments, the outside surface of the dial 150, 350, 550, 650 may feature textured ridges, grooves, or rubberized coatings which may enhance grip and improve handling, however, those skilled in the art, will appreciate the various elements that dial 150, 350, 550, 650 may include, after having the benefit of this disclosure.

In various embodiments, the dial 150, 350, 550, 650 may further comprise mechanical or electrical components which may translate rotational movement of the dial 150, 350, 550, 650 to a signal which may affect the vehicle feature 730. In many embodiments, the components within the dial 150, 350, 550, 650 may include a potentiometer, encoder, or switch assembly which may convert the dial's position into an electrical signal, however, those skilled in the art will appreciate the various other components that may assist in the aforementioned conversion, after having the benefit of this disclosure. In embodiments, the dial 150, 350, 550, 650 may additionally comprise visual indicators to provide real-time feedback on the current setting or status of the vehicle feature 730.

As previously mentioned, the selectively positionable interface component 210, 410 may comprise a rocker switch 252. In many embodiments, the rocker switch 252 may comprise a pivoting actuator or a lever that may be tilted in one direction to activate a function, however, those skilled in the art will appreciate the various other components of the rocker switch that may be included, after having the benefit of this disclosure. In the same or other embodiments, the rocker switch 252 may further include various visual indicators, such as an LED light, to indicate the current status of the vehicle feature 730 or to aid in the visibility of the rocker switch 252, such as in low light conditions.

In some embodiments, the vehicle control interface 100, 200, 300, 400, 500, 600, 700 for use within a vehicle 102, 602, 702 may comprise an electronic tablet, such as an Apple iPad or Google Pixel Tablet, without limitation. Those skilled in the art will appreciate the various electronic tablets that may be used, after having the benefit of this disclosure.

In the same or other embodiments, as previously mentioned, the selectively positionable interface component 210, 410 may comprise a display 440. The display 440 may present one or more variable inputs to a user via a graphic user interface (GUI) 442. Additionally, the display 440 may additionally comprise a digitizer. In the same or other embodiments, the digitizer may receive the variable inputs from a user which may correspond with a graphic user interface 442.

In one example, the display 440 may provide a visual representation of information output. The display 440 may present a user with icons, virtual buttons, interactive elements, and other presentations of data in a graphical format, which is provided via a graphical user interface (GUI) 442. The GUI may provide a user-friendly system that allows users to interact with electronic devices through graphical icons and visual indicators, as opposed to text-based interfaces, typed command labels, or text navigation.

The GUI 442 may be presented to the user on a display screen as a static and/or dynamic and interactive collection of virtual controls. The GUI 442 may show variable inputs to a user, meaning the information displayed can change based on the input received from the user and/or the system's internal processes. For example, the GUI 442 might display different control elements that are contextual to the vehicle feature being controlled, such as lighting level slider, climate adjustment, entertainment system settings, and/or other control inputs that may be related to other vehicle features that would be apparent to a person of skill in the art after having the benefit of this disclosure.

To facilitate interaction with the GUI 442, the display 440 often comprises a digitizer that may, for example, receive touch screen inputs. In one example, a digitizer may be provided as an overlay of a series of transparent electrodes placed over the screen of the display 440. When a user motions to touch the screen, the touch is received by the digitizer capable of detecting the precise location of the touch relative to the screen.

In one embodiment, the digitizer may be sensitive to touch and may recognize multiple touch points substantially simultaneously. This feature, commonly known to skilled artisans as multi-touch, may allow for more complex interactions with the display, such as zooming in or out by pinching or spreading two fingers on the screen, for example. The digitizer may send these touch inputs to the display processor and/or other processing unit for interpretation and action, such as the control input indicated by the touch being communicated to the vehicle communication radio by the communication module housed with the display.

In other embodiments, the selectively positionable interface component 210, 410 may employ various security features to safeguard against unauthorized access and ensure secure operation. The selectively positionable interface component 210, 410 may comprise data encryption for communication as well as user authentication methods, without limitation. Those skilled in the art will appreciate the various security features that may be added, after having the benefit of this disclosure.

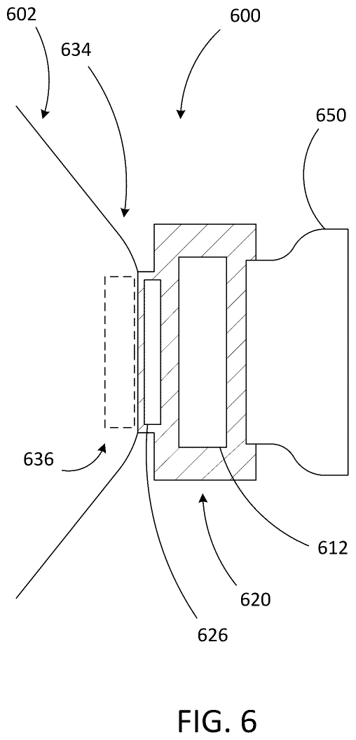

The communication module will now be discussed in greater detail. FIG. 6 highlights an example of the communication module, which may also be shown in other figures.

In various embodiments, the communication module 612 may be connected to the selectively positionable interface component 210, 410. The selectively positionable interface component 210, 410 may receive a control input, which was discussed in greater detail above. The communication module 612 may communicate this control input to the vehicle communication radio 732 of the vehicle 102, 602, 702, for example, via wireless transmission of electromagnetic radio waves. The vehicle communication radio 732 of the vehicle 102, 602, 702 may then receive the communication included by the electromagnetic radio waves received by the communication module and provide the control input indicated by the communication to the vehicle feature 730 via an electrical signal.

In the same or other embodiments, the vehicle feature 730 may communicate a vehicle feature status to the vehicle communication radio 732 of the vehicle 102, 602, 702. The vehicle communication radio 732 of the vehicle 102, 602, 702 may then communicate the vehicle feature status to the communication module 612. The vehicle feature status may then be communicated to the selectively positionable interface component 210, 410, via the communication module 612. In some embodiments, the selectively positionable interface component 210, 410 may display a status of the vehicle feature 730.

An illustrative process of wireless communication between a selectively positionable interface component and a vehicle will now be discussed for the purpose of clearly demonstrating an embodiment of the invention, without limitation. The process may begin with the reception of a control input as a digital signal, which may be provided by the selectively positionable interface component 210, 410. The digital signal may be provided as a binary representation of the input, which may promote accurate and efficient transmission of information.

Once the input is received and converted into a digital signal, it may then be communicated wirelessly via electromagnetic radio waves carrying the information encoded in the digital signal. The frequency of these waves determines the radio band used for transmission, which may be a usable and desirable frequency range as would be appreciated by those of skill in the art. The radio waves carrying the digital signal may then be received by a vehicle communication radio 732, which may be integrated into or communicably connected with the vehicle electronic control unit (ECU) and/or the vehicle feature being controlled 210, 410. In one embodiment, the vehicle communication radio 732 may be equipped with an antenna for receiving radio signals within a desired frequency band. The radio may demodulate the received signal, extracting the original digital signal from the modulated radio wave.

Once the digital signal is extracted, it may be translated back into a control input that represents the original input in a form that the vehicle's electronic systems can understand and act upon. The control input may then then be sent to a vehicle feature as an electrical signal. Depending on the nature of the control input, it could be sent to any number of vehicle features. For example, if the input was a command to unlock the doors, the electrical signal would be sent to the electronic control unit (ECU) responsible for the vehicle's central locking system. In another example, if the input was a command to increase the cabin temperature of a vehicle, the electrical signal would be sent to the climate control system responsible for ventilation and temperature control.

As previously mentioned, various embodiments may additionally include a vehicle communication radio 732. The vehicle communication radio 732 may be connected to at least one vehicle feature 730. The connection between the vehicle communication radio 732 and the at least one vehicle feature 730 may be made electrically, however, those skilled in the art will appreciate the various connections that may exist between the vehicle communication radio 732 and the vehicle feature 730, after having the benefit of this disclosure.

The housing will now be discussed in greater detail. FIGS. 2-6 highlight examples of the housing, which may also be shown in other figures.

In various embodiments, the housing 220, 320, 420, 520, 620 may substantially enclose the communication module 612. In the same or other embodiments, the housing 220, 320, 420, 520, 620 may additionally, at least partially, enclose the selectively positionable interface component 210, 410. The housing 220, 320, 420, 520, 620 may take on various shapes, corresponding to various locations of the vehicle 102, 602, 702. The housing 220, 320, 420, 520, 620 may be formed to fit within the vehicle's interior without creating a visual nuisance.

The housing 220, 320, 420, 520, 620 may additionally comprise a mounting interface, which will be discussed in greater detail below. The mounting interface 322 may removably attach the housing 220, 320, 420, 520, 620 to a vehicle mounting location 634 of the vehicle 102, 602, 702. The vehicle mounting location 634 may be a favorable location to which the vehicle control interface 100, 200, 300, 400, 500, 600, 700 may be temporarily attached to within the vehicle 102, 602, 702. A user may find it beneficial to change the vehicle mounting location 634 depending on the state of the vehicle 102, 602, 702. Thus, in various embodiments, there may be various vehicle mounting locations 634 for the same or different vehicle control interface 100, 200, 300, 400, 500, 600, 700.

A user may find it beneficial for the housing 220, 320, 420, 520, 620 to be made of one or more materials that may be beneficial for the constant use and/or movement of the vehicle control interface 100, 200, 300, 400, 500, 600, 700. These materials can include, but are not limited to, steel, aluminum, brass, copper, iron, wood, polycarbonate, polyethylene, polypropylene, polyethylene terephthalate, polyvinyl chloride, acrylonitrile-butadiene-styrene, and/or glass. Those skilled in the art will appreciate the variety of materials that may be used, after having the benefit of this disclosure.

In other embodiments, the housing 220, 320, 420, 520, 620 may further comprise additional elements that may provide additional functionality to the selectively positionable vehicle control interface 100, 200, 300, 400, 500, 600, 700. These may include, but are not limited to, a temperature sensor, a sound sensor, and/or a microphone. Those skilled in the art will appreciate the various additional elements that may provide additional functionality, after having the benefit of this disclosure.

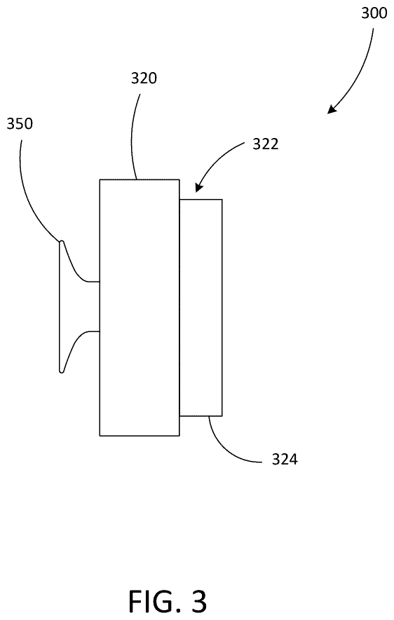

The mounting interface will now be discussed in greater detail. FIG. 3 highlights an example of the mounting interface, which may also be shown in other figures.

As previously mentioned, the housing 220, 320, 420, 520, 620 may additionally comprise a mounting interface 322. The mounting interface 322 may further exchangeably receive mounting hardware 324. The mounting hardware 324 may comprise a variety of mounting connections, including, but not limited to, a suctioning mechanism, a magnetic surface, a hook-and-loop surface, and/or an adhesive surface. Those skilled in the art, however, will appreciate the variety of mounting connections that may be used with the mounting hardware after having the benefit of this disclosure.

The mounting hardware 324 may comprise a suctioning mechanism 238. The suctioning mechanism 238 may create a temporary seal against the vehicle surface, allowing for a secure attachment. The suctioning mechanism 238 may operate by applying a downward pressure to expel air from the inside of the suctioning mechanism 238, creating a partial vacuum against the vehicle surface. The negative pressure within the suctioning mechanism 238 may create a firm seal to the vehicle surface. In the same or other embodiments, the suctioning mechanism 238 may be made of various flexible materials such as silicone or rubber, however, those skilled in the art, will appreciate the various other materials that may be used to make the suctioning mechanism 238, after having the benefit of this disclosure. Additionally, the suctioning mechanism 238 may feature a tab, lever, or similar release mechanism for detachment from the vehicle surface when desired, however, those skilled in the art will appreciate the various detachment mechanisms that suctioning mechanism 238 may incorporate, after having the benefit of this disclosure.

In various embodiments, the aforementioned mounting hardware 324 may have a complementary surface on a surface of the vehicle 102, 602, 702, such as the dashboard, console, pillar, or door, without limitation. In some embodiments, the mounting hardware 324 may favorably attach to the complementary surface of the vehicle 102, 602, 702. In the same or other embodiments, the complementary surface may be preinstalled, and, therefore may be predetermined.

In some embodiments, the mounting hardware 324 may comprise a magnet 626. In the same or other embodiments, the complementary surface of the vehicle 102, 602, 702 may comprise a complementary magnet 636. The magnet 626, located in the mounting hardware 324, and the complimentary magnet 636 located in the complementary surface may be made of a single material or composition of materials that exhibit at least some magnetism. The magnets may include substances such as those derived from iron, nickel, cobalt, rare-earth materials, and other materials that would be appreciated by a person of skill in the art, after having the benefit of this disclosure. The magnets may have an attractive force that draw other magnets through attractive properties of opposing magnetic poles.

In operation, a method may be provided for affecting operation of vehicle features using movable controls. Those of skill in the art will appreciate that the following methods are provided to illustrate an embodiment of the disclosure, and should not be viewed as limiting the disclosure to only those methods or aspects. Skilled artisans will appreciate additional methods within the scope and spirit of the disclosure for performing the operations provided by the examples below after having the benefit of this disclosure. Such additional methods are intended to be included by this disclosure.

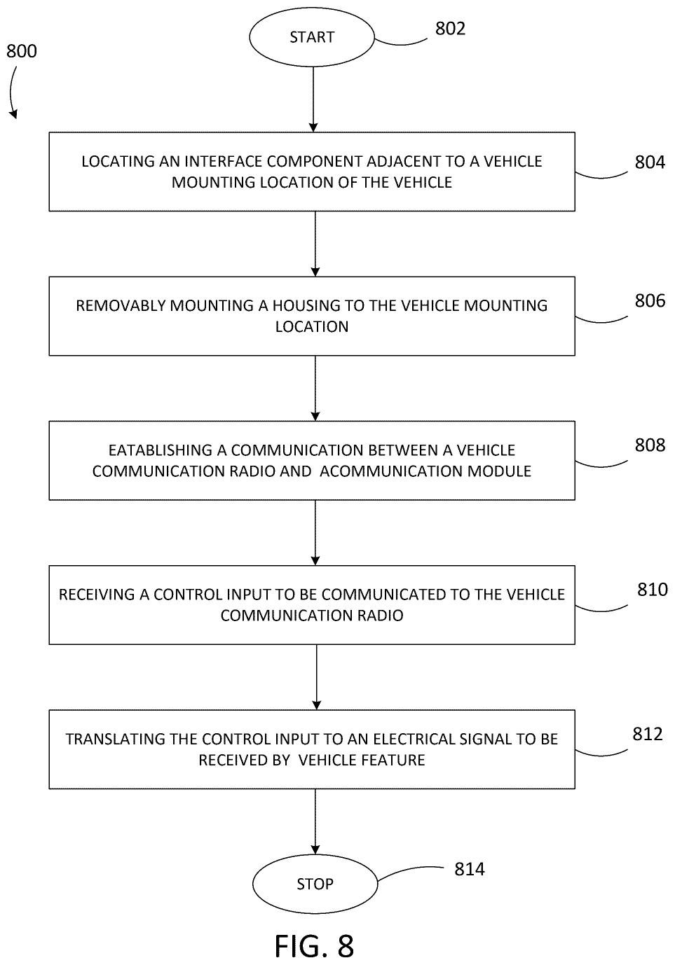

Referring now to flowchart 800 of FIG. 8, an illustrative method for using a selectively positionable vehicle control interface of a vehicle will be described, without limitation. Starting with Block 802, the operation may begin by locating a selectively positionable interface component adjacent to a vehicle mounting location of the vehicle (Block 804). The operation may continue with removably mounting a housing to the vehicle mounting location (Block 806). Then, the operation may continue by establishing a communication between a vehicle communication radio and a communication module (Block 808). Next, the operation may continue by receiving a control input to be relayed to the vehicle as a communication that is received by the vehicle communication radio (Block 810). Finally, the operation may continue by translating the control input to an electrical signal to be received by a vehicle feature (Block 812). The operation may end with Block 814.

While various aspects have been described in the above disclosure, the description of this disclosure is intended to illustrate and not limit the scope of the invention. The invention is defined by the scope of the appended claims and not the illustrations and examples provided in the above disclosure. Skilled artisans will appreciate additional aspects of the invention, which may be realized in alternative embodiments, after having the benefit of the above disclosure. Other aspects, advantages, embodiments, and modifications are within the scope of the following claims.

What is claimed is:

1. A vehicle control interface for use within a vehicle, comprising:
A selectively positionable interface component for receiving a control input to affect an operational state of a vehicle feature, comprising:
a communication module being preconfigured to communicate with a vehicle communication radio of the vehicle, and
wherein the vehicle communication radio is electrically connected to the vehicle feature being controlled by the control input;
a housing to substantially enclose the communication module and at least partially enclose the selectively positionable interface component, comprising:
a mounting interface to removably attach the housing to a vehicle mounting location of the vehicle.

2. The vehicle control interface of claim 1, wherein the mounting interface exchangeably comprises mounting hardware.

3. The vehicle control interface of claim 2, wherein the mounting hardware comprises a suctioning mechanism.

4. The vehicle control interface of claim 2, wherein the mounting hardware comprises a magnet corresponding to a complementary magnetic surface provided by the vehicle.

5. The vehicle control interface of claim 4, wherein the complementary magnetic surface is preinstalled to the vehicle.

6. The vehicle control interface of claim 1, wherein the selectively positionable interface component comprises a display comprising a screen that presents variable inputs via a graphic user interface.

7. The vehicle control interface of claim 6, wherein the display further comprises a digitizer to receive the control input corresponding with the variable inputs provided by the graphic user interface.

8. The vehicle control interface of claim 1, wherein the control input affects the operational state of an entertainment system of the vehicle.

9. The vehicle control interface of claim 1, wherein the control input affects the operational state of an interior light of the vehicle.

10. The vehicle control interface of claim 1, wherein the control input affects the operational state of a climate control system of the vehicle.

11. The vehicle control interface of claim 1, wherein the selectively positionable interface component comprises a dial.

12. The vehicle control interface of claim 1, wherein the selectively positionable interface component comprises a rocker switch.

13. A method for using a vehicle control interface within a vehicle to control a vehicle feature, comprising:
(a) positioning a selectively positionable interface component adjacent to a vehicle mounting location of the vehicle, the selectively positionable interface component comprising:
a communication module being preconfigured to communicate with a vehicle communication radio of the vehicle, and
wherein the vehicle communication radio is electrically connected to the vehicle feature being controlled;
(b) establishing a communication between the vehicle communication radio and the communication module;
(c) receiving a control input from the selectively positionable interface component by the vehicle communication radio via the communication; and
(d) translating the control input to an electrical signal to be received by the vehicle feature and affect an operational state of the vehicle feature.

14. The method of claim 13, wherein the selectively positionable interface component comprises a display comprising a screen that presents variable inputs via a graphic user interface and a digitizer, the method further comprising,
(e) receiving the control input via the digitizer corresponding with the variable inputs of the graphic user interface.

15. The method of claim 14:
wherein the communication module and at least part of the selectively positionable interface component are substantially enclosed by a housing that is removably attached to the vehicle mounting location via a mounting interface of the housing; and
wherein the method further comprises:
(f) removably mounting the mounting interface to the vehicle mounting interface.
